(19) United States
(12) Patent Application Publication
(10) Pub. No.: US 2019/0343303 A1
(43) Pub. Date: Nov. 14, 2019

(54) Mounting Assembly for Interchanging Decorative Pieces

(71) Applicant: Lisa Watt, Copperpolis, CA (US)

(72) Inventor: Lisa Watt, Copperpolis, CA (US)

(21) Appl. No.: 15/978,937

(22) Filed: May 14, 2018

(51) Int. Cl. A47G 1/16; F16B 7/00; F16M 13/02

(52) U.S. Cl. CPC A47G 1/1606; F16M 13/02; F16B 7/00

(57) ABSTRACT

Systems and methods for a mounting assembly in accordance with embodiments of the invention are disclosed. In one embodiment a mounting assembly includes a first mounting piece having a base portion and a first protruding portion. The embodiment may further include an interchangeable mounting piece having a second protruding portion such that the interchangeable mounting piece is configured slide inside the first protruding portion of the first mounting piece. The embodiment may further include pin member may be configured to be inserted in the first pair of apertures and the second pair of apertures when the first mounting piece and the interchangeable mounting piece are in a mated position. The embodiment may further include a second interchangeable mounting piece configured to be replaceable with the interchangeable mounting piece.

### FIELD OF THE INVENTION

The present invention generally relates to mounting assemblies and more specifically to mounting assemblies to mount decorative items to walls.

### BACKGROUND

Reconfiguring the decor within a living space may be difficult and tedious, especially when reconfiguring items to be mounted to a wall. Changing a look or theme of a room may be difficult, particularly when trying to mount items such as paintings, candles, and vases to a wall having a rock wall facade. Thus, there is a need to easily and quickly change the decorative features or items of a room.

### SUMMARY OF THE INVENTION

The various embodiments of the present mounting assembly contain several features, no single one of which is solely responsible for their desirable attributes. Without limiting the scope of the present embodiments, their more prominent features will now be discussed below. In particular, the present mounting assemblies will be discussed in the context of mounting decorative items to a pre-existing wall or embedding the mounting assemblies in a rock wall. However, the use of the following embodiments are merely exemplary and various other mounting assemblies may be utilized for mounting decorative items to a wall as appropriate to the requirements of a specific application in accordance with various embodiments of the invention. After considering this discussion, and particularly after reading the section entitled “Detailed Description,” one will understand how the features of the present embodiments provide the advantages described here.

In a first aspect, a mounting assembly may include a first mounting piece having a base portion and a first protruding portion, wherein a distal end of the first protruding portion includes a pair of apertures such that a first aperture is opposite a second aperture. The mounting assembly may further include an interchangeable mounting piece having a second protruding portion that includes a second pair of apertures comprising a third aperture that is opposite a fourth aperture, wherein the interchangeable mounting piece is configured slide inside the first protruding portion of the first mounting piece such that the first pair of apertures and the second pair of apertures are aligned, and a pin member configured to be inserted in the first pair of apertures and the second pair of apertures when the first mounting piece and the interchangeable mounting piece are in a mated position, and a second interchangeable mounting piece configured to be replaceable with the interchangeable mounting piece, the second interchangeable mounting piece including a third protruding portion that includes a third pair of apertures comprising a fifth aperture and sixth aperture, wherein the second interchangeable mounting piece is configured to slide inside the first protruding portion of the first mounting piece such that the first pair of apertures and the third pair of apertures are aligned, wherein the base portion of the first mounting piece includes at least one base portion aperture, such that the base portion is configured to be securely attached to a wall.

In an embodiment of the first aspect, at least the distal end of the post of the first mounting piece may be visible when securely attached to a wall.

In another embodiment of the first aspect, the first mounting piece may be a T-shaped bracket.

In another embodiment of the first aspect, a cross-section of the protruding portion is at least one selected from a rectangle, square, circle, and oval.

In another embodiment of the first aspect, a shape of the interchangeable mounting piece may be one selected from a hoop, a hook, a rectangular trough, a circular trough, a flat face, a swirled hook, and a decorative finial.

In another embodiment of the first aspect, the mounting assembly may further include a base plate having an aperture configured to be disposed around an outer surface of the protruding portion of the first mounting piece.

In another embodiment of the first aspect, the first mounting piece, may be in a mated position with both the interchangeable mounting piece and the base plate.

In another embodiment of the first aspect, the mounting assembly may further include a detachable mounting piece configured to engage with the interchangeable mounting piece.

In another embodiment of the first aspect, at least one of the first mounting piece, the interchangeable mounting piece, and the second interchangeable mounting piece may be made of at least one selected from steel, aluminum, titanium, and acrylonitrile butadiene Styrene (ABS).

In another embodiment of the first aspect, the at least one of the first mounting piece, the interchangeable mounting piece, and the second interchangeable mounting piece may be formed by at least one selected from welding, injection molding, and 3D printing.

In another embodiment of the first aspect, the at least one of the first mounting piece, the interchangeable mounting piece, and the second interchangeable mounting piece may have a finish selected from matte black, glossy black, white, chrome brushed nickel, oil rubbed bronze, copper, brass, and patina.

In a second aspect, a method of attaching a mounting assembly to a pre-existing wall may include abutting a first mounting piece against a wall surface such that a base portion of the first mounting piece is flush against the wall and a protruding portion of the first mounting piece protrudes away from the wall surface, wherein a distal end of the protruding portion includes a pair of apertures such that a first aperture is opposite a second aperture, affixing the first mounting piece to the wall surface, sliding a portion of a first interchangeable mounting piece into the distal end of the protruding portion of the first mounting piece such that a second pair of apertures of second mounting piece are aligned with the first pair of apertures, securing the first and second mounting pieces together, and replacing the first interchangeable mounting piece with a second interchangeable mounting piece.

In another embodiment of the second aspect, the replacing the first interchangeable mounting piece with a second interchangeable mounting piece may include removing the second mounting piece, sliding a portion of a subsequent second mounting piece into the distal end of the post of the first mounting piece, and securing the first and subsequent second mounting pieces together.

In another embodiment of the second aspect, the affixing may include using one of at least a nail, screw, or anchor screw to fasten the first mounting piece to the wall surface.

In another embodiment of the second aspect, the securing may include placing a pin through the first pair of apertures and the second pair of apertures.

In another embodiment of the second aspect, the method of attaching a mounting assembly to a pre-existing wall may further include disposing a base plate around an outer surface of the protruding portion of the first mounting piece prior to securing the second mounting piece.

In another embodiment of the second aspect, the method of attaching a mounting assembly to a pre-existing wall may further include hanging a detachable ornamental piece from the interchangeable mounting piece.

In a third aspect, a method of embedding a mounting assembly into a wall may include applying a scratch coat to a wall surface, abutting a first mounting piece against the scratch coat on the wall surface such that a base portion of the first mounting piece is flush against the wall and a protruding portion of the first mounting piece protrudes away from the wall surface, wherein a distal end of the protruding portion includes a pair of apertures such that a first aperture is opposite a second aperture, affixing the first mounting piece to the wall surface, notching out a recess in a first stone to be applied to the scratch coat on the wall surface such that the recess will allow the first post of the first mounting piece to protrude through the first stone, and laying the first stone proximate the first mounting piece such that at least the distal end of the post protrudes from an outer surface of the first stone and the pair of apertures are visible.

In an embodiment of the second aspect, the method of embedding a mounting assembly into a wall may further include notching at least a second recess in a second stone to be applied to the scratch coat on the wall surface such that the recess may allow the first post of the first mounting piece to protrude through the second stone.

In an embodiment of the second aspect, the method of embedding a mounting assembly into a wall may further include sliding a portion of a first interchangeable mounting piece into the distal end of the protruding portion of the first mounting piece such that a second pair of apertures of second mounting piece may be aligned with the first pair of apertures, securing the first and second mounting pieces together, and replacing the first interchangeable mounting piece with a second interchangeable mounting piece.

### BRIEF DESCRIPTION OF THE DRAWINGS

The various embodiments of the present mounting assembly now will be discussed in detail with an emphasis on highlighting the advantageous features. These embodiments depict the novel and non-obvious mounting assembly shown in the accompanying drawings, which are for illustrative purposes only. These drawings include the following figures:

FIG. 1 is a snapshot of an installed mounting assembly in accordance with an embodiment of the invention.

FIG. 2A illustrates a side view of a mounting assembly in accordance with an embodiment of the invention.

FIG. 2B illustrates another side view of a mounting assembly in accordance with an embodiment of the invention.

FIG. 3A illustrates a perspective view of a first mounting piece of the mounting assembly in accordance with an embodiment of the invention.

FIG. 3B illustrates a side view of a first mounting piece of the mounting assembly in accordance with an embodiment of the invention.

FIG. 4A illustrates a perspective view of an interchangeable mounting piece of the mounting assembly in accordance with an embodiment of the invention.

FIG. 4B illustrates a top view of an interchangeable mounting piece of the mounting assembly in accordance with an embodiment of the invention.

FIG. 5A illustrates a perspective view of another interchangeable mounting piece of the mounting assembly in accordance with an embodiment of the invention.

FIG. 5B illustrates a side view of another interchangeable mounting piece of the mounting assembly in accordance with an embodiment of the invention.

FIG. 6A illustrates a perspective view of another interchangeable mounting piece of the mounting assembly in accordance with an embodiment of the invention.

FIG. 6B illustrates a side view of another interchangeable mounting piece of the mounting assembly in accordance with an embodiment of the invention.

FIG. 7A illustrates a side view of another interchangeable mounting piece of the mounting assembly in accordance with an embodiment of the invention.

FIG. 7B illustrates a top view of another interchangeable mounting piece of the mounting assembly in accordance with an embodiment of the invention.

FIG. 8 illustrates a cross sectional side view of another interchangeable mounting piece of the mounting assembly in accordance with an embodiment of the invention.

FIG. 9A illustrates a cross sectional side view of another interchangeable mounting piece of the mounting assembly in accordance with an embodiment of the invention.

FIG. 9B illustrates a front view of another interchangeable mounting piece of the mounting assembly in accordance with an embodiment of the invention.

FIG. 10 illustrates a cross sectional side view of another interchangeable mounting piece of the mounting assembly in accordance with an embodiment of the invention.

FIG. 11A illustrates a perspective view of a detachable ornamental piece of the mounting assembly in accordance with an embodiment of the invention.

FIG. 11B illustrates a front view of a detachable ornamental piece of the mounting assembly in accordance with an embodiment of the invention.

FIG. 12 illustrates a system view of an installed mounting assembly with a detachable ornamental piece in accordance with an embodiment of the invention.

FIG. 13A illustrates a perspective view of a base plate of a mounting system in accordance with an embodiment of the invention.

FIG. 13B illustrates a front view of a base plate of a mounting system in accordance with an embodiment of the invention.

FIG. 14 is a flow chart illustrating a method for attaching a mounting assembly to a preexisting wall in accordance with an embodiment of the invention.

FIG. 15 is a flow chart illustrating a method for replacing a first interchangeable mounting piece with a second interchangeable mounting piece in accordance with an embodiment of the invention.

FIG. 16 is a flow chart illustrating another method for attaching a mounting assembly to a preexisting wall in accordance with an embodiment of the invention.

FIG. 17 is a flow chart illustrating a method of embedding a mounting assembly in a rock wall in accordance with an embodiment of the invention.

### DETAILED DESCRIPTION OF THE DRAWINGS

The following detailed description describes the present embodiments with reference to the drawings. In the drawings, reference numbers label elements of the present embodiments. These reference numbers are reproduced below in connection with the discussion of the corresponding drawing features.

Turning now to the drawings, mounting assemblies for mounting various decorative pieces in accordance with embodiments of the invention are disclosed. In many embodiments, a user may be provided with a number of options for securely mounting various decorative items including, but not limited to, candles, vases, and/or paintings to a wall. In several embodiments, mounting assemblies in accordance with embodiments of the invention may be used to provide users with a system to easily reconfigure which decorative items are mounted to the wall. Mounting assemblies in accordance with embodiments of the invention are further discussed below.

### Mounting Assembly Overview

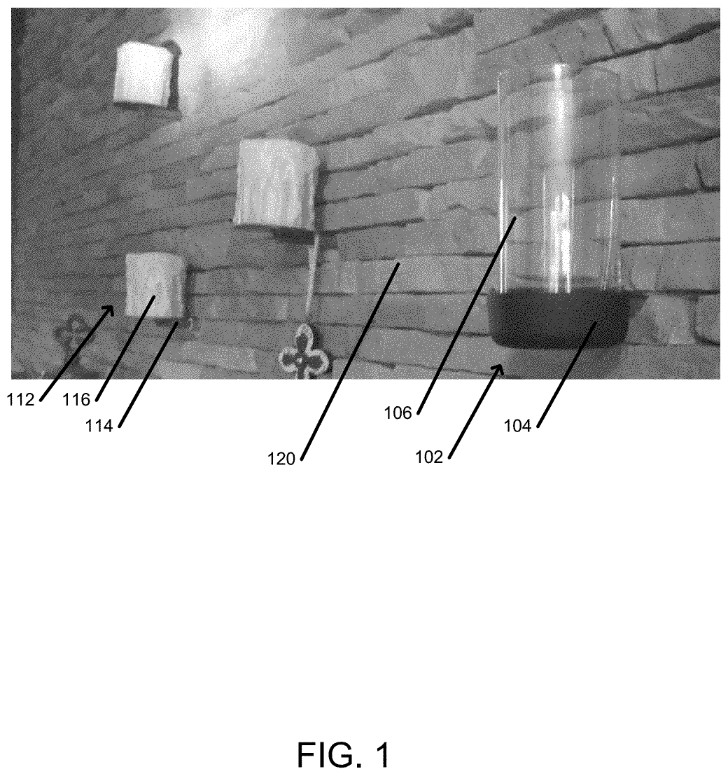

Mounting assemblies in accordance with embodiments of the present disclosure may be used to mount decorative items to a wall. A snapshot illustrating mounting assemblies 102, 112 installed in an interior rock wall 120 in accordance with embodiments of the present disclosure is illustrated in FIG. 1. According to some embodiments, the mounting assembly 102 may include an interchangeable mounting piece 104 supporting a decorative piece, such as but not limited to, a vase 106. Likewise, according to some embodiments, the mounting assembly 112 may include an interchangeable mounting piece 114 supporting a decorative piece, such as but not limited to, a decorative candle 116.

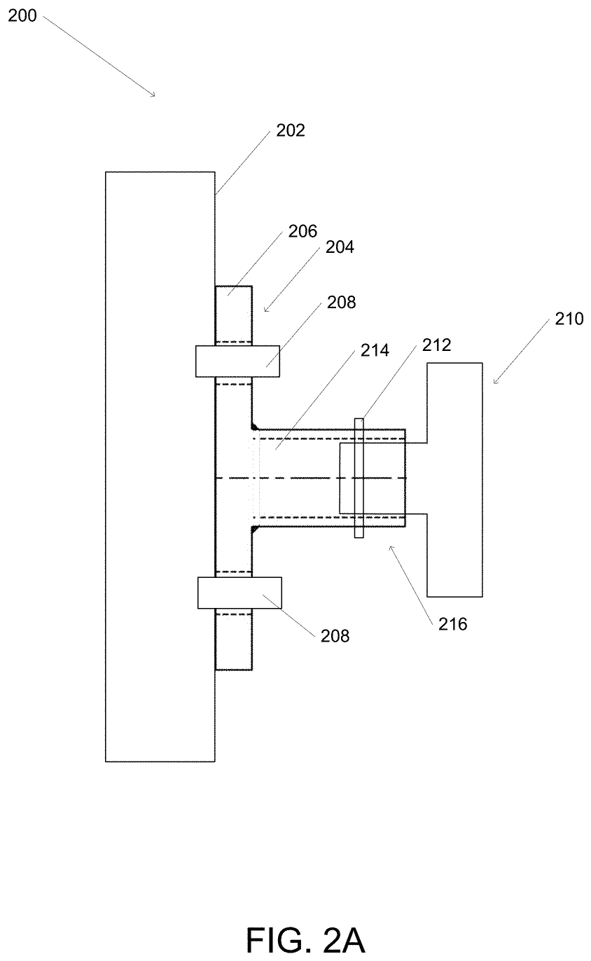

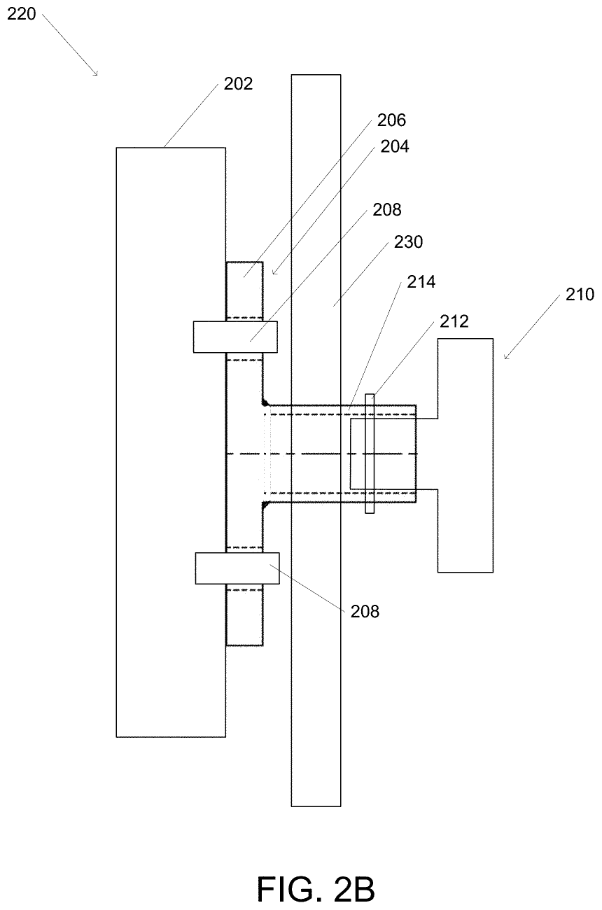

A side view of a mounting assembly in accordance with embodiments of the present disclosure is illustrated in FIG. 2A. The mounting assembly 200 may include a first mounting piece 204 having a base portion 206 that may be mounted to a wall 202, as further described below. The first mounting piece 204 may also include a protruding portion 214 having a distal end 216. For example, the base portion 206 may be screwed into the wall 202 with screws 208 to secure the first mounting piece 204 to the wall. The mounting assembly 200 may further include an interchangeable mounting piece (may also be referred to as “second mounting piece”) 210 configured to mate with the protruding portion 214 of the first mounting piece 204, as further described below. In a variety of embodiments, a pin member 212 may be used to secure the first mounting piece 204 to the interchangeable mounting piece 210, as further described below. As further described below, there may be multiple variations of the interchangeable mounting piece 210. For example, in many embodiments, the interchangeable mounting piece 210 may be decorative in nature or may be configured to hold or support a decorative item such as a vase, candle, painting, etc. Thus, the mounting assembly 200 may not be limited by any particular arrangement, including the interchangeable mounting piece 210 shown in FIG. 2A, as other variations of the interchangeable mounting piece may be mated with the first mounting piece 206.

A side view of another mounting assembly 220 in accordance with embodiments of the present disclosure is shown in FIG. 2B. Similar to FIG. 2A, in various embodiments, mounting assemblies may include a first mounting piece 204 having a base portion 206 mounted to the wall 202 with screws 208, and may further include an interchangeable mounting piece 210 configured to mate with the first mounting piece 204. In several embodiments, a base plate 230 may be placed around the perimeter of the protruding portion 214 of the first mounting piece 204. In a variety of embodiments, a pin member 212 may be used to secure the first mounting piece 204 to the interchangeable mounting piece 210 and base plate 230, as further described below.

As further described below, there may be multiple variations of the interchangeable mounting piece. For example, the interchangeable mounting piece may be decorative in nature or may be configured to hold or support a decorative item such as a vase or painting. Thus, the mounting assemblies 200, 220 are not limited by arrangement including the interchangeable mounting piece 210 shown in FIGS. 2A-B, as other variations of the interchangeable mounting piece may be mated with the first mounting piece 204. Similarly, mounting assemblies described herein are not limited by the base plate 230. For example, other base plate designs may be used as described further below.

In several embodiments, if the user desires to reconfigure the mounted decoration, the user may remove the pin member 212 and un-mate the interchangeable mounting piece 210 from the first mounting piece 204. In such embodiments, the user may then optionally replace this initial interchangeable mounting piece with a second interchangeable mounting piece, where the second interchangeable mounting piece may have a different decorative feature from the initial interchangeable mounting piece.

Although specific mounting assemblies with particular versions of first mounting pieces, interchangeable mounting pieces, and base plates are discussed above with respect to FIGS. 1-2B, any of variety of mounting assemblies including various first mounting pieces, interchangeable mounting pieces, and base plates as appropriate to the requirements of a specific application can be utilized in accordance with embodiments of the invention. A first mounting piece in accordance with embodiments of the invention are discussed further below.

### First Mounting Pieces

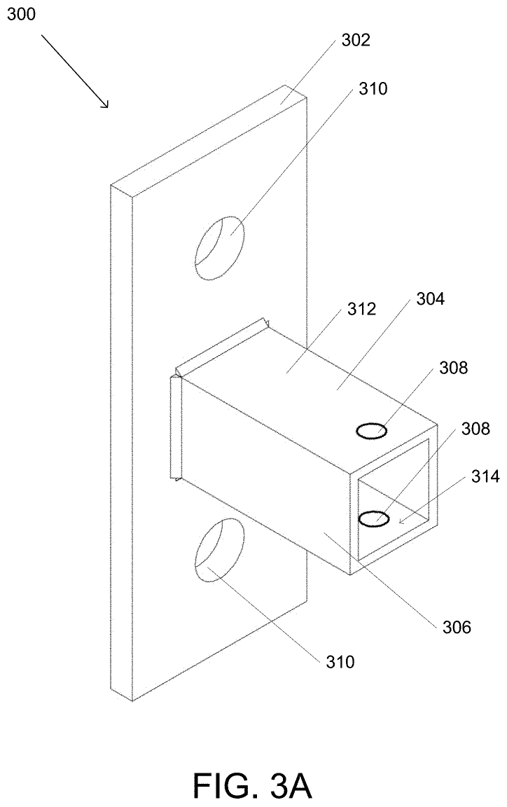

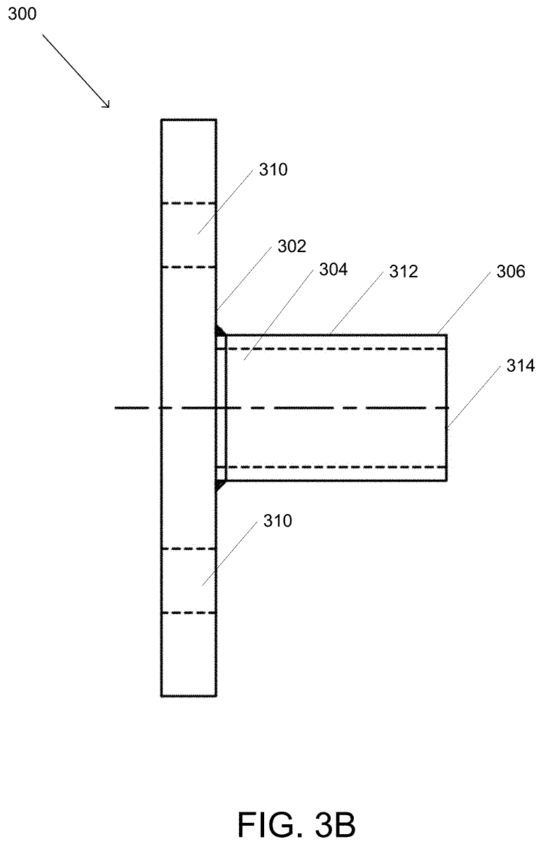

The first mounting piece (may also be referred to as an “anchor”) may be used to secure a mounting assembly to a wall. A first mounting piece 300 in accordance with embodiments of the present disclosure is shown in FIG. 3A. The first mounting piece 300 may include a base portion 302 and a protruding portion 304 such that the first mounting piece 300 resembles a T-shaped bracket.

In various embodiments, the base portion 302 may be configured to abut against a wall (not illustrated). In some embodiments, the base portion 302 may be rectangular, as shown in FIG. 3A. In other embodiments, the base portion may be circular, oval, or any other shape suitable for abutting against a wall and/or preferred by a user. As shown in FIG. 3A, the base portion 302 may include at least one aperture 310. The aperture 310 may allow a fastener (not shown) to be inserted therein in order to secure the base portion 302 to the wall. Although FIG. 3A illustrates two apertures 310, a base portion may include any number of apertures or no aperture.

In reference to FIG. 3A, the first mounting piece 300 may include a protruding portion 304 extending from the base portion 302. For example, the protruding portion 304 may extend from a central area of the base portion 302. However, the first mounting piece 300 may be configured to have a protruding portion 304 extend from any location of the surface of the base portion 302. In some embodiments, the protruding portion 304 may be rectangular in shape and may be comprised of an outer wall 312 such that the outer wall 312 forms an opening 314 at a distal end 306 configured to receive an interchangeable mounting piece (not shown), as further described below.

In further reference to FIG. 3A, the distal end 306 of the protruding portion 304 may include at least a pair of apertures 308. In some embodiments, the apertures 308 may be arranged so that they are opposite of each other on the outer wall 312 of the protruding portion 304 so that a pin (not shown) may be inserted through the pair of apertures 308 when installed.

A side view of a first mounting piece 300 is illustrated in FIG. 3B. in many embodiments, a first mounting piece 300 may include a base portion 302 having at least one aperture 310. The first mounting piece 300 may also include a protruding portion 304 extending from the base portion 302 and away from the wall (not illustrated). The protruding portion 304 may comprise an outer wall 312, such that an opening 314 is formed at a distal end 306 configured to receive an interchangeable mounting piece (not shown).

Although FIGS. 3A and 3B, are described with respect to particular versions of a first mounting piece 300, one skilled in the art will understand that various embodiments of a first mounting piece may be used in accordance with embodiments of the invention. For example, the shape of the protruding portion 304 created by the outer wall 312, may be circular, oval, triangular, or any shape suitable for receiving an interchangeable mounting piece. Further, the first mounting piece may be formed from any material such as (but not limited to) steel, aluminum, titanium, or any metal or metal alloy suitable for welding. In addition, the first mounting piece may include a finish selected from various finishes such as (but not limited to) matte black, glossy black, white, chrome brushed nickel, oil rubbed bronze, copper, brass, and patina. The first mounting piece may also be formed from acrylonitrile butadiene styrene (ABS) or any plastic suitable for injection molding or 3D printing. For example, the first mounting piece may be formed by welding, injection molding or 3D printing. However, this disclosure is not intended to be limited by the materials or method of manufacture. An interchangeable mounting piece in accordance with embodiments of the invention are discussed below.

### Interchangeable Mounting Pieces

Second mounting pieces or interchangeable mounting pieces in accordance with embodiments of the present disclosure may be used to attach decorative items to the mounting assembly or may serve as a decorative piece itself, as described further below.

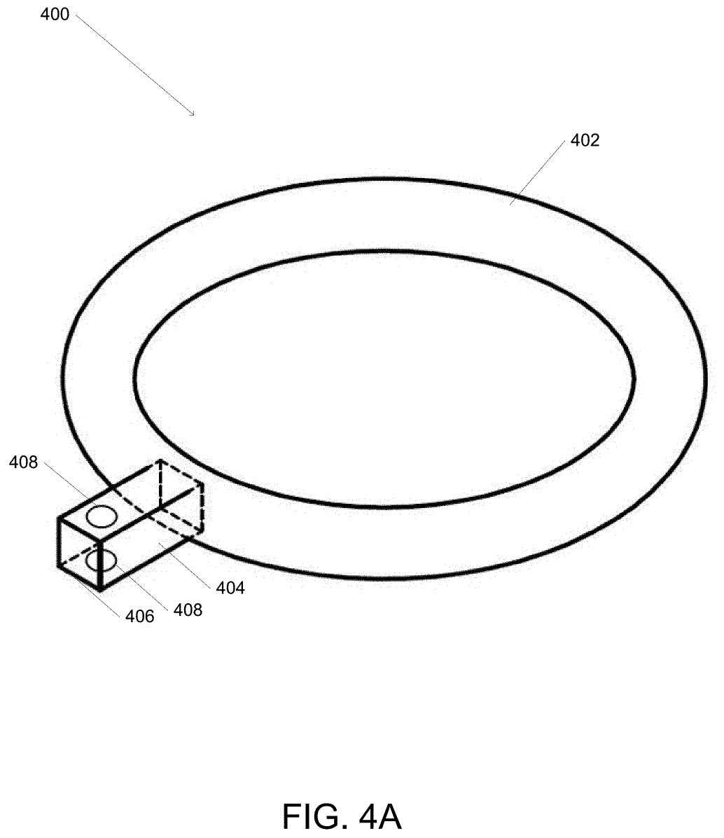

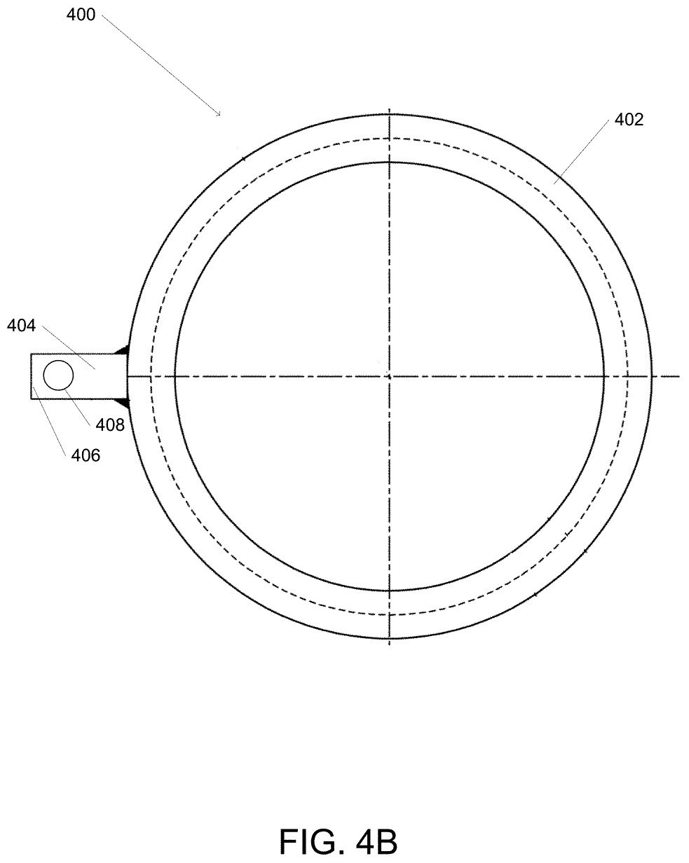

A perspective view of an interchangeable mounting piece 400 in accordance with embodiments of the present disclosure is shown in FIG. 4A. The interchangeable mounting piece 400 may include a ring portion 402 and a protruding portion 404. The ring portion 402 may be a circular ring configured to receive a decorative item such but not limited to a vase or a candle. For example, a vase (not illustrated) with a conical profile may be inserted into the ring portion 402, such that the ring portion 402 may support the vase.

In further reference to FIG. 4A, the protruding portion 404 may extend from an outer surface of the ring portion 402. The protruding portion 404 may be configured to be received by a protruding portion of the first mounting piece, such as (but not limited to), for example, the first mounting piece 300 (FIGS. 3A-B). In some embodiments, the protruding portion 404 may be rectangular in shape, as shown in FIG. 4A. According to other embodiments, the protruding portion 404 may be circular, oval, or any suitable shape configured to be received by the first mounting piece. As shown in FIG. 4A, the protruding portion 404 may include at least a pair of apertures 408. The apertures 408 may be arranged to be located opposite of each other on a distal end 406 of the protruding portion 404 so that a pin (not shown) may be inserted through the pair of apertures 408 when the protruding portion 404 is received by the protruding portion of the first mounting piece.

A top view of the interchangeable mounting piece 400 is provided in FIG. 4B. Again, the interchangeable mounting piece 400 may include a ring portion 402 having a protruding portion 404 extending from an outer surface of the ring portion 402. The protruding portion 404 may include a distal end 406 configured to be received by a first mounting piece. The distal end 406 may include a pair of apertures 408 located opposite of the other for receiving a pin to secure the interchangeable mounting piece 400 to a first mounting piece.

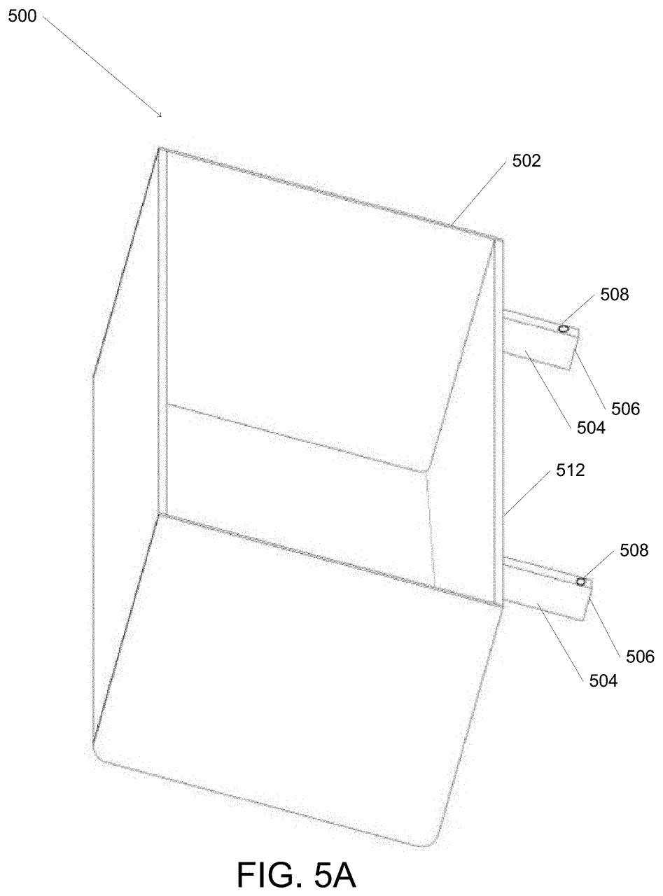

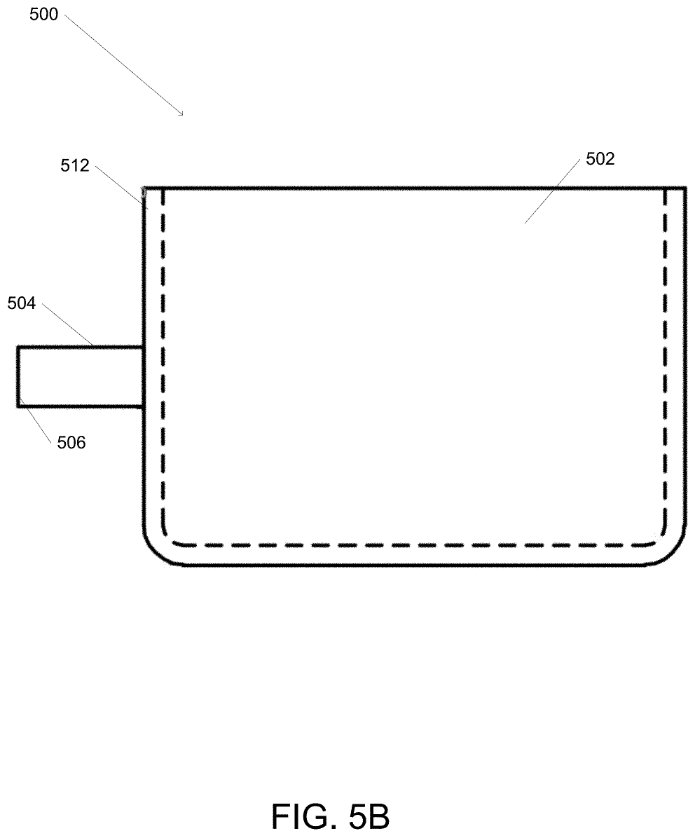

A perspective view of another interchangeable mounting piece 500 in accordance with embodiment of the present disclosure is shown in FIG. 5A. The interchangeable mounting piece 500 may include at least a trough portion 502 and one or more protruding portion(s) 504. The trough portion 502 may be a rectangular trough configured to receive decorative items such as, but not limited to vases, candles, or any decorative items that may fit therein. For example, a plurality of candles (not illustrated) may be arranged in the trough portion 502, such that the trough portion 502 may support the candles. According to some embodiments, a combination of various decorative items may be placed in the trough portion 502, such as a candle and a vase. The embodiments disclosed herein are not to be limited by the arrangement of items placed in the trough portion 502.

In further reference to FIG. 5A, the one or more protruding portion(s) 504 may extend from an outer surface 512 of the trough portion 502. As shown in FIG. 5A, the interchangeable mounting piece 500 may include two protruding portions 504 extending from the trough portion 502. For example, a sidewall 512 of trough portion 502 may have protruding portions 504 located on opposite ends. Having more than one protruding portion 504 may provide more support for the interchangeable mounting piece 500 and any decorative items placed therein. Although interchangeable mounting piece 500 is illustrated in FIG. 5A with two protruding portions 504, this disclosure is not limited by the number and arrangement or location on the sidewall 512 of protruding portions 504. For example, according to some embodiments the trough portion 502 may include one protruding portion 504 or three protruding portions 504 or any other number of protruding portions 504.

Each of the protruding portion(s) 504 may be configured to be received by a protruding portion of a first mounting piece, for example, the first mounting piece 300 as described above with respect to FIGS. 3A-B. In such embodiments, each protruding portion 504 may be received by a protruding portion of a different first mounting piece that are spaced apart to receive however many protruding portions the interchangeable mounting piece may have. In some embodiments, the protruding portion(s) 504 may be rectangular in shape, as shown in FIG. 5A. According to other embodiments, the protruding portions 504 may be circular, oval, or be any suitable shape configured to be received by the first mounting piece. As illustrated in FIG. 5A, each protruding portion 504 may include at least a pair of apertures 508. The apertures 508 are arranged to be located opposite of each other on a distal end 506 of each protruding portion 504 so that a pin (not illustrated) may be inserted through the pair of apertures 508.

A side view of the interchangeable mounting piece 500 is provided in FIG. 5B. As described above, the interchangeable mounting piece 500 may include a trough portion 502 having at least one protruding portion 504 extending from a sidewall 512 thereof. The protruding portion 504 may include a distal end 506 configured to be received by a first mounting piece. The distal end 506 may include a pair of apertures (not shown) located opposite of the other for receiving a pin to secure the interchangeable mounting piece 500 to a first mounting piece.

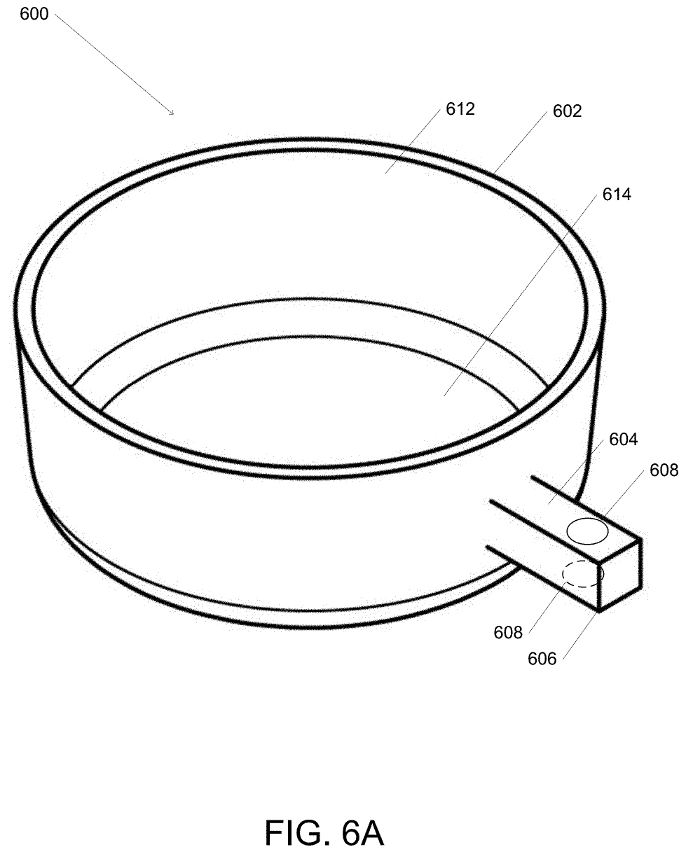

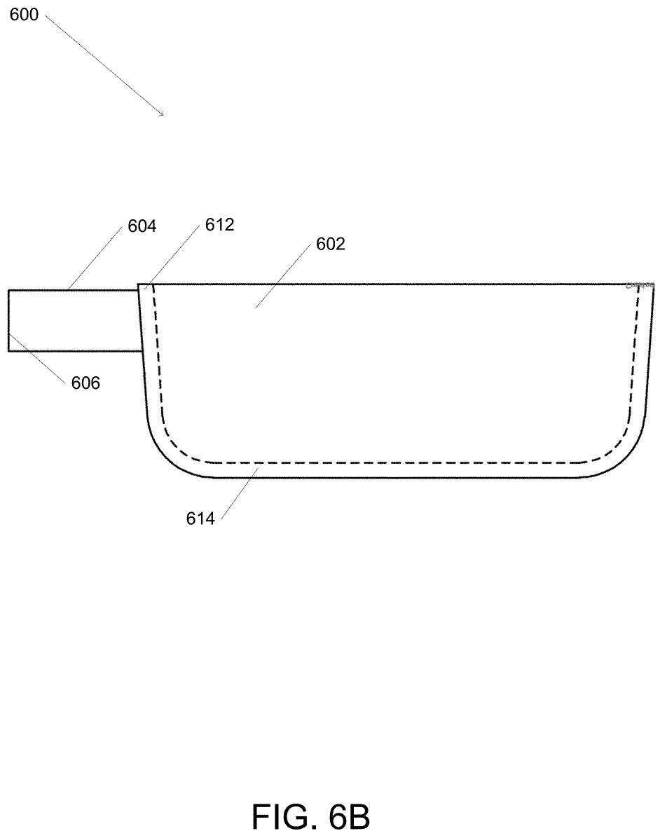

A perspective view of an interchangeable mounting piece 600 is shown in FIG. 6A. The interchangeable mounting piece 600 may include at least a round trough portion 602 and a protruding portion 604 extending therefrom. The round trough portion 602 may include a cylindrical wall 612 having a bottom surface 614. The round trough portion 602 may be configured to receive a decorative item such as, but not limited to, a vase or a candle. For example, a candle (not shown) may be placed in the round trough portion 602, such that the bottom surface 614 may support the candle.

In further reference to FIG. 6A, the protruding portion 604 may extend from an outer surface of the cylindrical wall 612. The protruding portion 604 may be configured to be received by a protruding portion of the first mounting piece, such as (but not limited to), for example, a first mounting piece 300 (FIGS. 3A-B). In some embodiments, the protruding portion 604 may be rectangular in shape, as shown in FIG. 6A. According to other embodiments, the protruding portion 604 may be circular, oval, or be any suitable shape configured to be received by the first mounting piece. The protruding portion 604 may include at least a pair of apertures 608. The apertures 608 may be arranged to be located opposite of each other on a distal end 606 of the protruding portion 604 so that a pin (not shown) may be inserted through the pair of apertures 608 when the protruding portion 604 is received by the protruding portion of the first mounting piece.

A side view of the interchangeable mounting piece 600 is provided in FIG. 6B. Again, the interchangeable mounting piece 600 may include a circular trough portion 602 having a cylindrical sidewall 612 and a bottom surface 614. The interchangeable mounting piece 600 may include at least one protruding portion 604 extending from the cylindrical sidewall 612 of the circular trough portion 602. The protruding portion 604 may include a distal end 606 configured to be received by a first mounting piece, for example, first mounting piece 300 as described in FIGS. 3A and 3B. The distal end 606 may include a pair of apertures (not shown) located opposite of the other for receiving a pin member (not shown) to secure the interchangeable mounting piece 600 to a first mounting piece.

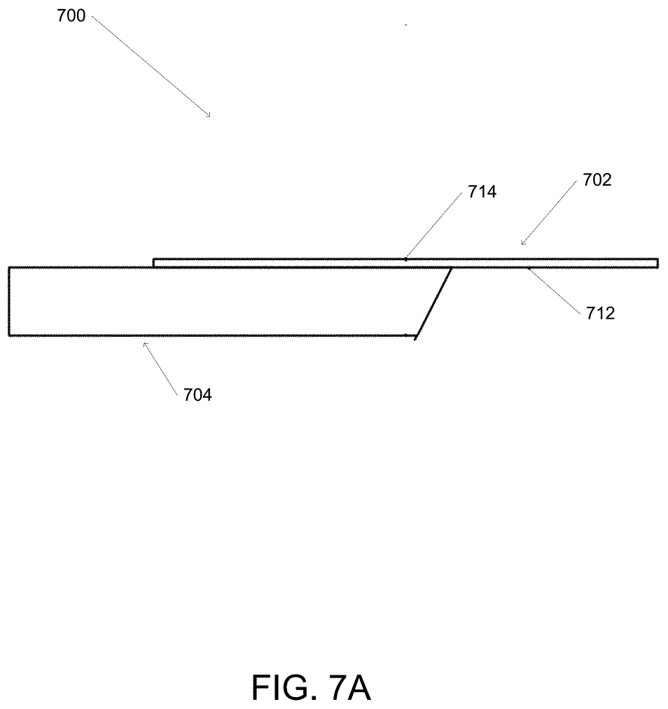

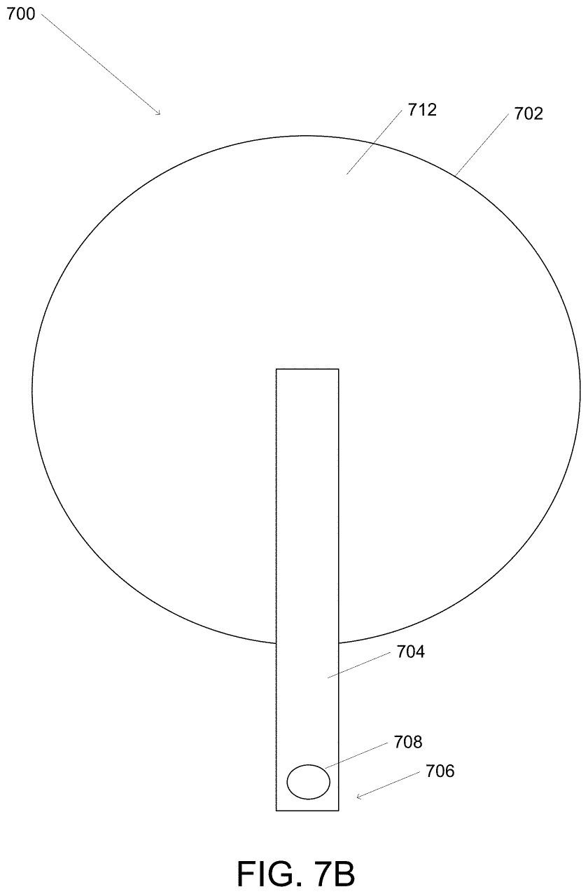

A side view of an interchangeable mounting piece 700 is shown in FIG. 7A. The interchangeable mounting piece 700 may include a flat portion 702 having an upper face 714 and a lower face 712. The interchangeable mounting piece 700 may also include a protruding portion 704 extending from the lower face 712, oriented parallel to the upper face 714 and the lower face 712 of the flat portion 702. The upper surface 714 of the flat portion 702 may be configured to receive a decorative item such as, but not limited to, a vase or a candle. For example, a candle may be placed on the flat portion 702, such that the upper face 714 supports the candle.

A bottom view of the interchangeable mounting piece 700 is provided in FIG. 7B. Again, the interchangeable mounting piece 700 may include a flat portion 702 having an upper face (not shown) and a lower face 712. The interchangeable mounting piece 700 may also include a protruding portion 704 extending from the lower face 712, oriented parallel to the surface of the lower face 712. The protruding portion 704 may include a distal end 706 configured to be received by a first mounting piece, such as (but not limited to) for example, the first mounting piece 300 (3A-B).

As shown in FIGS. 7A and 7B, the protruding portion 704 may be rectangular in shape, however, it is understood that the protruding portion 704 may be any suitable shape configured to be received by a first mounting piece, such as (but not limited to) for example, the first mounting piece 300 (3A-B). The protruding portion 704 may include at least a pair of apertures 708. The apertures 708 are arranged to be located opposite of each other on a distal end 706 of the protruding portion 704 so that a pin (not shown) may be inserted through the pair of apertures 708 when the protruding portion 704 is received by the protruding portion of the first mounting piece.

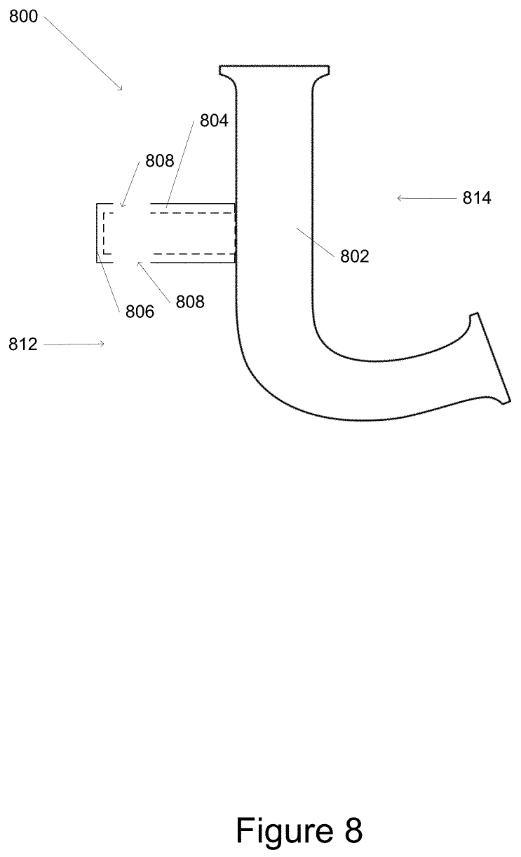

A cross-sectional side view of an interchangeable mounting piece 800 is shown in FIG. 8. The interchangeable mounting piece 800 may include a hook portion 802 having a front side 814 and a backside 812. The interchangeable mounting piece 800 may further include a protruding portion 804 extending from the backside 812 of the hook portion 802. The front side 814 of the hook portion 802 may be configured to receive a decorative item such as, but not limited to, a vase with a handle, a picture or painting, a detachable decorative item described further below, or any decorative item that has a hanging attachment.

The protruding portion 804 may extend from the backside 812 of the hook portion 802. The protruding portion 804 may be configured to be received by a first mounting piece, such as (but not limited to) for example, the first mounting piece 300 (3A-B). In some embodiments, the protruding portion 804 may be rectangular in shape, as shown in FIG. 8. According to other embodiments, the protruding portion 804 may circular, oval, or be any suitable shape configured to be received by the first mounting piece. The protruding portion 804 may include at least a pair of apertures 808. The apertures 808 may be arranged to be located opposite of each other on a distal end 806 of the protruding portion 804 so that a pin (not shown) may be inserted through the pair of apertures 808 when the protruding portion is received by the protruding portion of the first mounting piece.

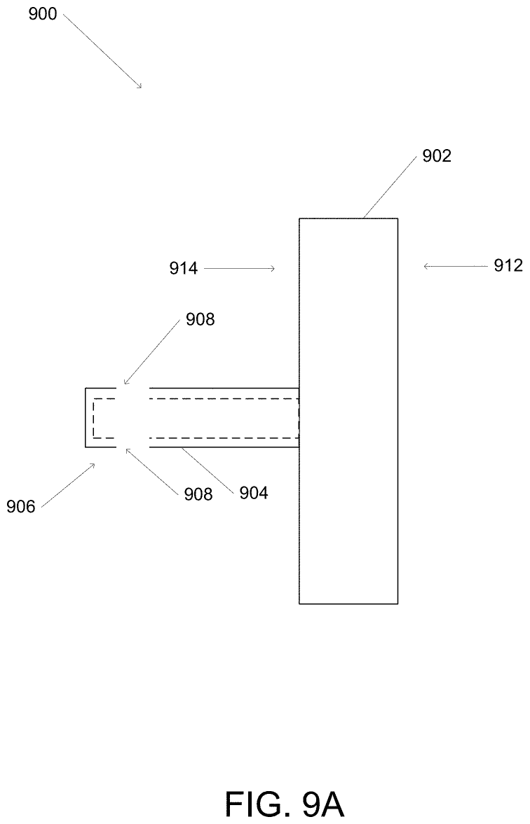

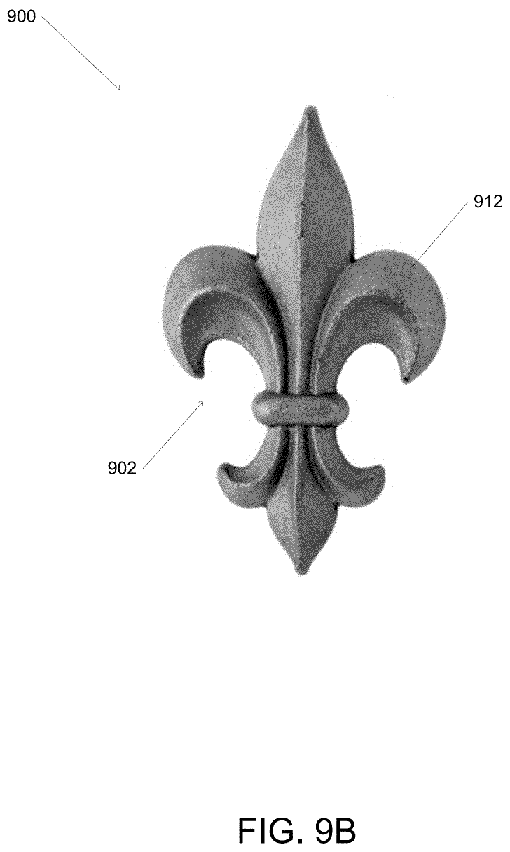

A cross-sectional side view of an interchangeable mounting piece 900 is shown in FIG. 9A. The interchangeable mounting piece 900 may include a finial portion 902 and a protruding portion 904 extending therefrom. The finial portion 902 may include a front decorative face 912 and a rear face 914. The front face 912 of the finial portion 902 may serve as a decorative item. For example, referring to FIG. 9B, a front view of an interchangeable mounting piece 900 is shown where the front face 912 of the finial portion 902 is decorative.

Referencing again to FIG. 9A, a protruding portion 904 may extend from a rear face 914 of the finial portion 902. The protruding portion 904 may be configured to be received by a protruding portion of the first mounting piece, such as (but not limited to) for example, the first mounting piece 300 (3A-B). In some embodiments, the protruding portion 904 may be rectangular in shape, as shown in FIG. 9A. According to other embodiments, the protruding portion 904 may circular, oval, or be any suitable shape configured to be received by the first mounting piece. The protruding portion 904 may include at least a pair of apertures 908. The apertures 908 may be arranged to be located opposite of each other on a distal end 906 of the protruding portion 904 so that a pin (not shown) may be inserted through the pair of apertures 908 when the protruding portion is received by the protruding portion of the first mounting piece.

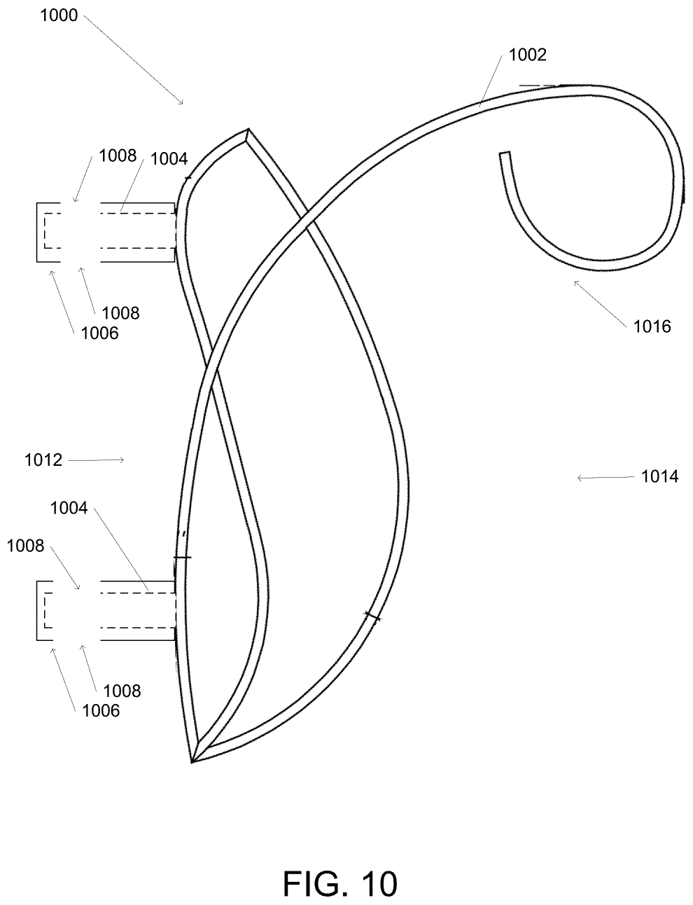

A cross-sectional side view of an interchangeable mounting piece 1000 is shown in FIG. 10. The interchangeable mounting piece 1000 may include a swirled hook portion 1002 and one or more protruding portion(s) 1004 extending therefrom. The swirled hook portion 1002 may include a backside 1012 and a front side 1014. The front side 1014 may be configured to include a hook portion 1016. The hook portion 1016 may be configured to receive a decorative item such as, but not limited to, a vase with a handle, a picture or painting, a detachable decorative item described further below, or any decorative item that has a hanging attachment.

In further reference to FIG. 10, the one or more protruding portion(s) 1004 may extend from the backside 1012 of the swirled hook portion 1002. As shown in FIG. 10, protruding portions 1004 may extend from more than one location of the backside 1012 of the swirled hook portion 1002. For example, the backside 1012 may have two protruding portions 1004 located on opposite ends of the swirled hook portion 1002. Having more than one protruding portion 1004 may provide more support for the interchangeable mounting piece 1000 and any decorative items hung therefrom. Although interchangeable mounting piece 1000 is illustrated in FIG. 10 with two protruding portions 1004, this disclosure is not limited to the number or arrangement of protruding portions 1004 illustrated in FIG. 10. For example, according to some embodiments the swirled hook portion 1002 may include one protruding portion 1004 or three protruding portions 1004 or any other number of protruding portions.

Each of the protruding portion(s) 1004 may be configured to be received by a first mounting piece, such as (but not limited to) for example, the first mounting piece 300 (3A-B). In such embodiments, each protruding portion 1004 may be received by a protruding portion of a different first mounting piece that are spaced apart to receive however many protruding portions the interchangeable mounting piece may have. In some embodiments, the protruding portion(s) 1004 may be rectangular in shape, as shown in FIG. 10. According to other embodiments, the protruding portion 1004 may circular, oval, or be any suitable shape configured to be received by the first mounting piece. The protruding portion 1004 may include at least a pair of apertures 1008. The apertures 1008 are arranged to be located opposite of each other on a distal end 1006 of the protruding portion 1004 so that a pin (not shown) may be inserted through the pair of apertures 1008.

Embodiments of the interchangeable mounting pieces may be formed from any material such as (but not limited to) steel, aluminum, titanium, or any metal or metal alloy suitable for welding. In addition, the interchangeable mounting piece may include a finish selected from various finishes such as (but not limited to) matte black, glossy black, white, chrome brushed nickel, oil rubbed bronze, copper, brass, and patina. The interchangeable mounting pieces may also be formed from acrylonitrile butadiene styrene (ABS) or any plastic suitable for injection molding or 3D printing. For example, the interchangeable mounting pieces may be formed by welding, injection molding or 3D printing. However, this disclosure is not intended to be limited by the materials or method of manufacture.

Although FIGS. 4A-10, are described with respect to particular versions of the interchangeable mounting piece, one skilled in the art will understand that various embodiments of the interchangeable mounting piece may be used in accordance with embodiments of this disclosure. For example, the shape of the protruding portion of the interchangeable mounting piece may vary depending on the shape of the corresponding protruding portion of the first mounting piece. Additionally, mounting assemblies in accordance with the embodiments of the present disclosure may include detachable ornamental pieces, which are discussed further below.

### Detachable Ornamental Pieces

Mounting assemblies in accordance with embodiments of this disclosure may further include a variety of detachable ornamental pieces. According to some embodiments, the detachable ornamental pieces may be used to support other decorative items such as, but not limited to, vases, candles, and other decorative items. According to some embodiments, the detachable ornamental pieces may be used as decorative additions.

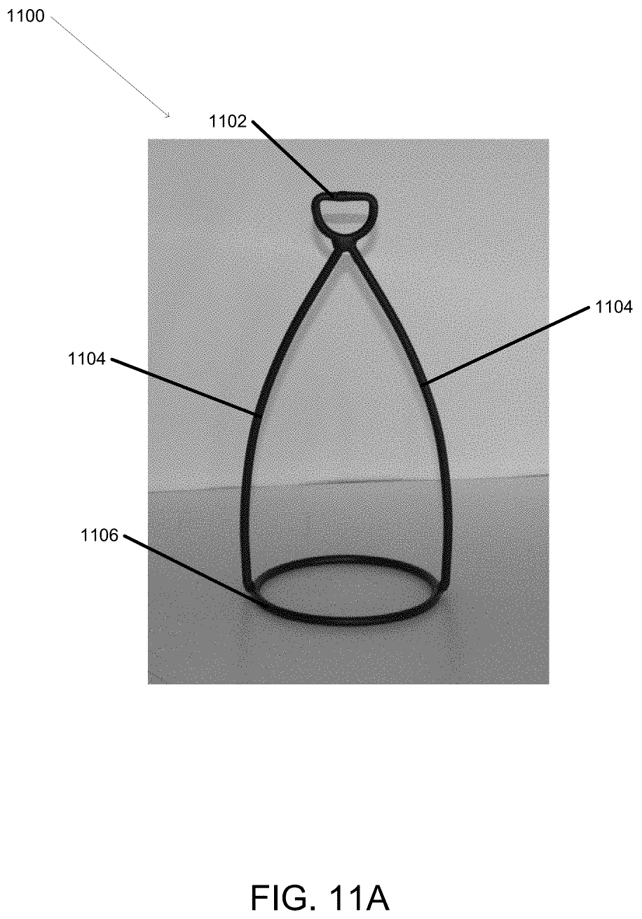

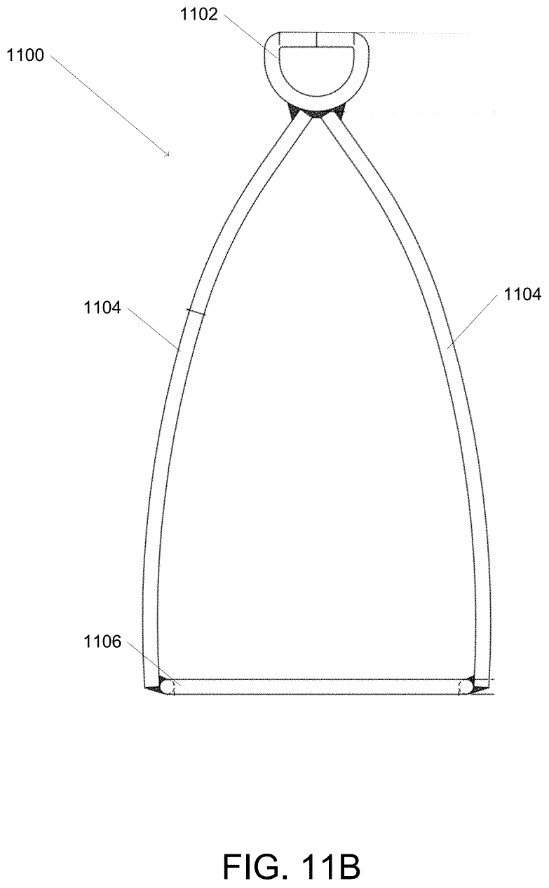

In reference to FIG. 11A, a detachable ornamental piece 1100 may include a hanging attachment 1102, for hanging from an interchangeable mounting piece. The detachable ornamental piece 1100 may further include a leg portion located below the hanging attachment. For example, FIG. 11A shows two leg portions 1104 located below the hanging attachment 1102. A lower end of the leg portion 1104 may be connected to a hoop portion 1106. The hoop portion 1106 may be configured to receive a decorative item such as, but not limited to, a vase or a candle.

In reference to FIG. 11 B, a detachable ornamental piece 1100 in accordance with embodiments of this disclosure may include a hanging attachment 1102, at least two leg portions 1104 disposed beneath the hanging attachment, and a hoop portion 1106 located at a lower end of the at least two leg portions 1104. The hoop portion 1106 may be configured to receive a decorative item such as, but not limited to, a vase or a candle. For example, a vase with a conical profile may be inserted into the hoop portion 1106, such that the hoop portion 1106 may support the vase.

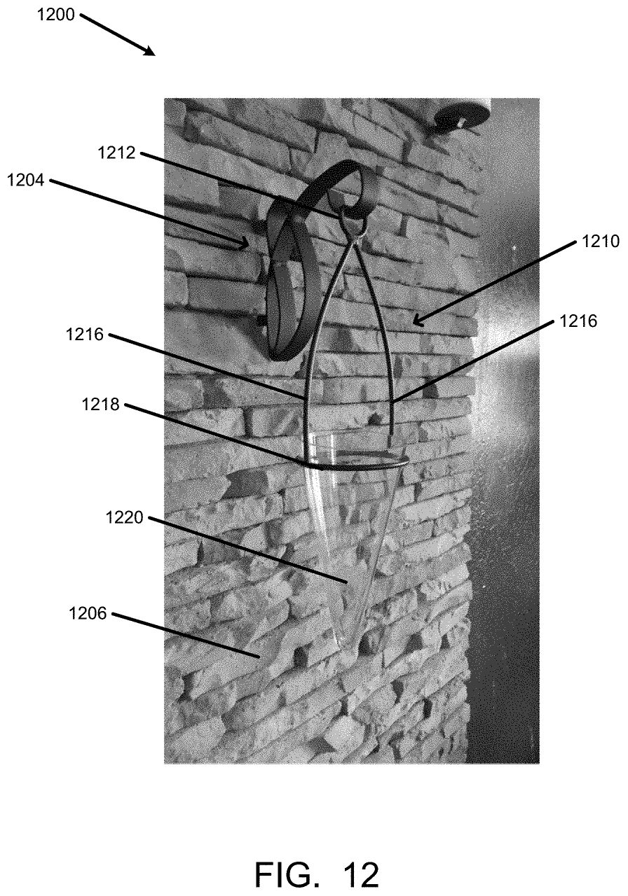

For example, in reference to FIG. 12 a mounting assembly 1200 including a detachable ornamental piece 1210 in accordance with embodiments of this disclosure is illustrated. According to embodiments of this disclosure a first mounting piece 1204 may be installed in a rock wall 1206. The hanging attachment 1212 of detachable ornamental piece 1210 may be attached or hung from the first mounting piece 1204. The at least two leg portions 1216 may connect the hanging attachment 1212 to the hoop portion 1218. As illustrated in FIG. 12, a vase 1220 with a conical profile may be inserted into the hoop portion 1218, such that the hoop portion 1218 may support the vase 1220.

Although FIGS. 11A-12, are described with respect to particular versions of the detachable ornamental piece 1100, 1210, one skilled in the art will understand that various embodiments of a detachable ornamental piece may be used in accordance with embodiments of the invention.

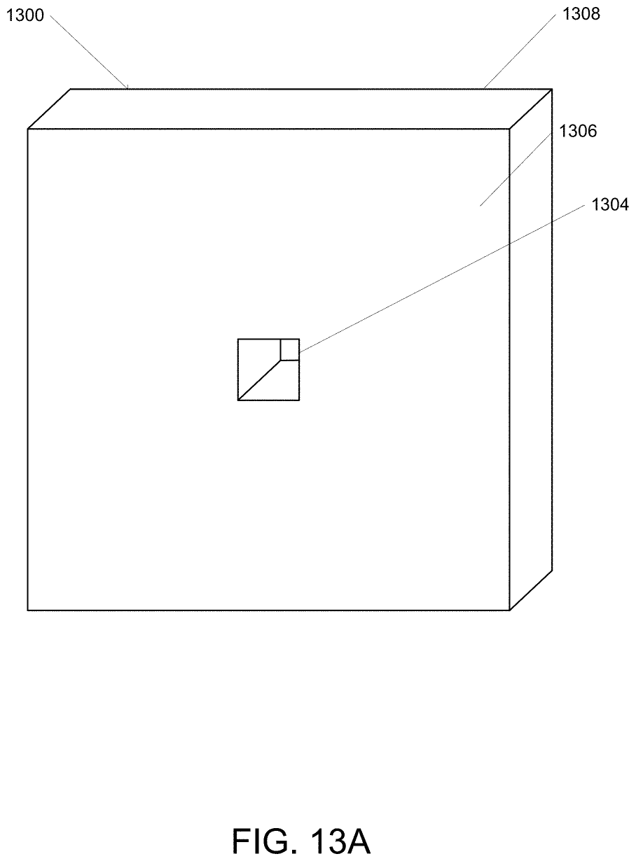

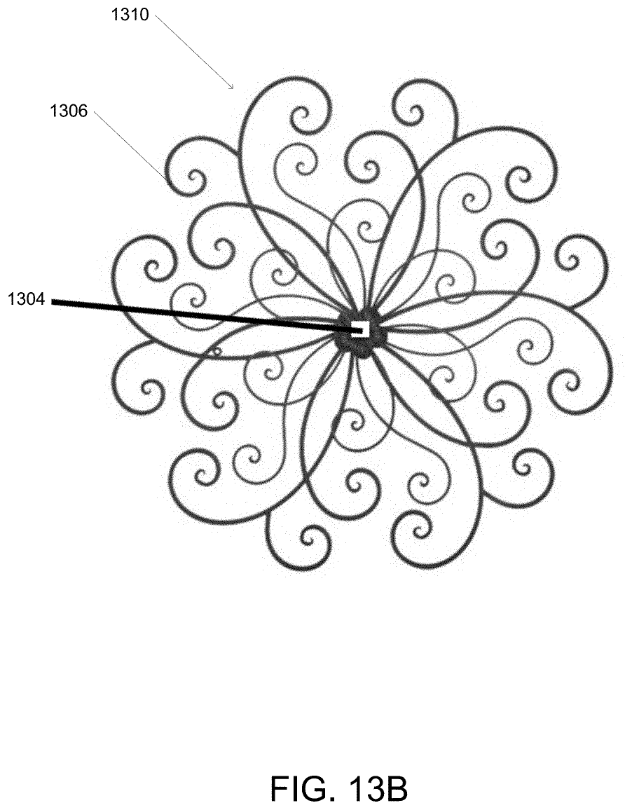

According to embodiments of the present disclosure detachable ornamental pieces may additionally include base plates, which may be used as a decorative addition to the mounting assembly. A perspective view of a base plate 1300 is shown in FIG. 13A. The base plate 1300 may include a first face 1306 and a second face 1308. The first face 1306 and the second face 1308 may be located on opposite faces of the base plate 1300.

The base plate may further include an interior hole 1304 that extends from the first face 1306 through the base plate 1300 and ends at the second face 1308. The base plate 1300 is configured to be disposed around an outer perimeter of a protruding portion, such as (but not limited to) for example, the protruding portion 304 of the first mounting piece 300 (FIGS. 3A-B). In some embodiments, the shape of the interior hole 1304 may correspond to the shape of the protruding portion of the first mounting piece. However, the shape of the interior hole 1304 is not limited to the shape of the protruding portion of the first mounting piece and may be any suitable hole shape. Although the interior hole 1304 is located in a center region of the base plate 1300 as seen in FIG. 13A, embodiments of the present disclosure may include an interior hole located at a location other than the center region of the base plate 1300, for example, near an end of the base plate.

According to some embodiments the first face 1306 and the second face 1308 may have the same decorative features. For example, as shown in FIG. 13B the first face 1306 has the same decorative features as the second face of the base plate 1310. According to some embodiments, the first face 1306 and the second face 1308 may have different decorative features. For example, the first face may include an image that does not appear on the second face. Although FIGS. 13A and 13B, are described with respect to particular versions of the base plate 1300, one skilled in the art will understand that various embodiments of a base plate may be used in accordance with embodiments of the invention.

Embodiments of the detachable ornamental pieces may be formed from any material such as (but not limited to) steel, aluminum, titanium, or any metal or metal alloy suitable for welding. The detachable ornamental pieces may include a finish selected from various finishes such as (but not limited to) matte black, glossy black, white, chrome brushed nickel, oil rubbed bronze, copper, brass, and patina. The detachable ornamental pieces may also be formed from acrylonitrile butadiene styrene (ABS) or any plastic suitable for injection molding or 3D printing. The detachable ornamental pieces may be formed by welding, injection molding or 3D printing. However, this disclosure is not intended to be limited by the materials or method of manufacture. Methods for installing and using the mounting assembly in accordance with embodiments of the invention are discussed below.

### Installing and Using the Mounting Assembly

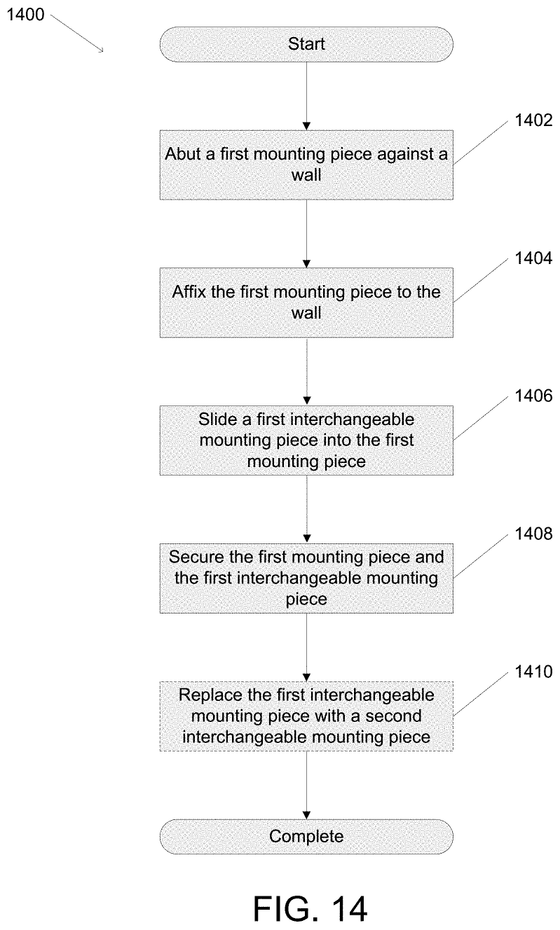

The mounting assembly may be installed to a pre-existing wall or may be embedded into a wall being built, for example, a rock wall. A process for installing and using a mounting assembly in accordance with embodiments of the present disclosure is shown in FIG. 14. The process 1400 may include abutting (1402) a first mounting piece against a wall. For example, a base portion of the first mounting piece may be abutted against a wall, as described above. In some embodiments, the wall may be drywall. In some embodiments, the first mounting piece may be abutted against the wall near a stud or between studs. The process 1400 may also include affixing (1404) the first mounting piece to the wall with at least one fastener. The fastener may be one selected from a nail, screw, or anchor screw, however this disclosure is not intended to be limited by the type of fastener used to affix the first mounting piece to the wall.

In some embodiments, a first interchangeable mounting piece may be mated to the first mounting piece by sliding (1406) the first interchangeable mounting piece into a distal end of a protruding portion of the first mounting piece, as described above. The distal end of the protruding portion may include a pair of apertures located opposite of each other of the protruding portion. The first interchangeable mounting piece may also include a pair of apertures located opposite of each other, as described above. The pair of apertures on the first mounting piece and the first interchangeable mounting piece may be aligned when the first interchangeable mounting piece is mated with the first mounting piece. The first mounting piece and the first interchangeable mounting piece may be secured (1408) together by disposing a pin member through the aligned pairs apertures of the first mounting piece and the first interchangeable mounting piece, as described above.

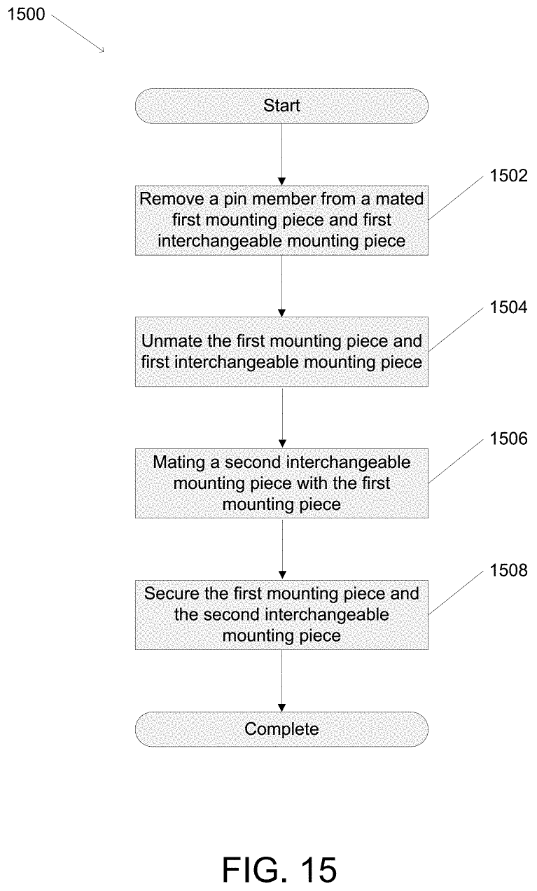

In some embodiments the first interchangeable mounting piece may further include replacing (1410) the first interchangeable mounting piece with a second interchangeable mounting piece. A process for replacing (1410) a first interchangeable mounting piece with a second interchangeable mounting piece in accordance with embodiments of the present disclosure is shown in FIG. 15. The process 1500 may include removing (1502) the pin member from the pairs of apertures of the first mounting piece and the first interchangeable mounting piece, such that the pin member is removed from the mated first mounting piece and the second interchangeable mounting piece, as described above. Further, the first interchangeable mounting piece may be unmated (1504) from the first mounting piece.

A second interchangeable mounting piece may be mated (1506) to the first mounting piece by sliding the second interchangeable mounting piece into a distal end of a protruding portion of the first mounting piece. The distal end of the protruding portion may include a pair of apertures located opposite of each other of the protruding portion, as described above. The second interchangeable mounting piece may also include a pair of apertures located opposite of each other, as described above. The pair of apertures on the first mounting piece and second interchangeable mounting piece may be aligned when the second interchangeable mounting piece is mated with the first mounting piece. The first mounting piece and the second interchangeable mounting piece may be secured (1508) together by disposing a pin member through the aligned pairs apertures of the first mounting piece and the interchangeable mounting piece.

According to some embodiments, the second interchangeable mounting piece may be a different design from the first interchangeable mounting piece. For example, the first interchangeable mounting piece may have a ring portion as described in FIG. 4A, while the second interchangeable mounting piece may have a round trough portion as described in FIG. 6A. According to some embodiments, the second interchangeable mounting piece may have the same design as the first interchangeable mounting piece. For example, both the first and second interchangeable mounting pieces may include a ring portion as described in FIG. 4A.

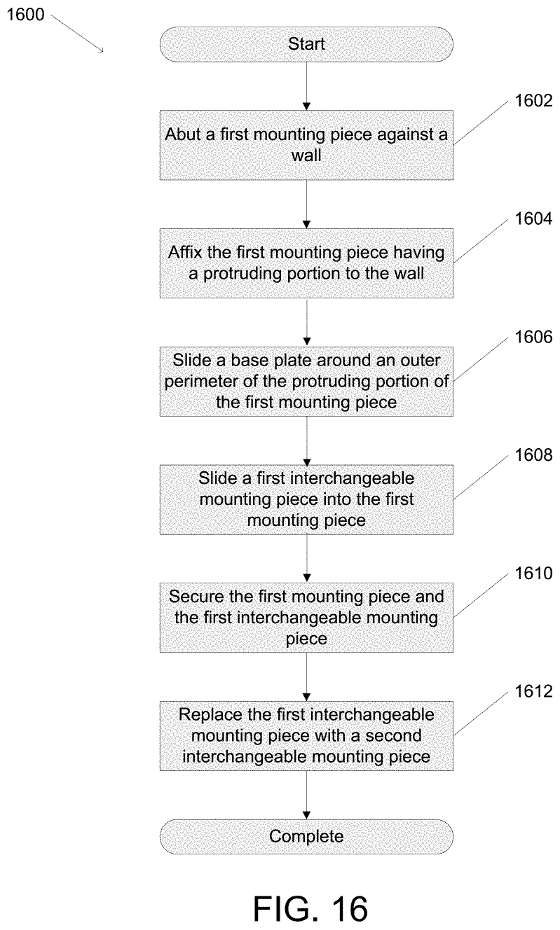

A process for installing and using a mounting assembly including a base plate in accordance with embodiments of the present disclosure is shown in FIG. 16. The process for installing and using a mounting assembly including a base plate 1600 may include abutting (1602) a first mounting piece against a wall. For example, a base portion of the first mounting piece may be abutted against a wall, as described above. In some embodiments, the wall may be drywall. In some embodiments, the first mounting piece may be abutted against the wall near a stud or between studs. The process 1600 may also include affixing (1604) the first mounting piece to the wall with at least one fastener. The fastener may be one selected from a nail, screw, or anchor screw, however this disclosure is not intended to be limited by the type of fastener used to affix the first mounting piece to the wall.

In some embodiments, a base plate may be mated to the first mounting piece by sliding (1606) the base plate around an outer perimeter of the protruding portion of the first mounting piece. In some embodiments, an interchangeable mounting piece may be mated to the first mounting piece by sliding (1608) the interchangeable mounting piece into a distal end of a protruding portion of the first mounting piece, as described above. The distal end of the protruding portion may include a pair of apertures located opposite of each other of the protruding portion. The interchangeable mounting piece may also include a pair of apertures located opposite of each other, as described above. The pair of apertures on the first mounting piece and the interchangeable mounting piece may be aligned when the interchangeable mounting piece is mated with the first mounting piece. The first mounting piece and the interchangeable mounting piece may be secured (1610) together by disposing a pin member through the aligned pairs apertures of the first mounting piece and the first interchangeable mounting piece, as described above. In some embodiments the first interchangeable mounting piece may further include replacing (1612) the first interchangeable mounting piece with a second interchangeable mounting piece, as described above.

While the above description contains many specific embodiments of the invention, these should not be construed as limitations on the scope of the invention, but rather as an example of one embodiment thereof. For example, the interchangeable mounting piece may be secured to the first mounting piece prior to the first mounting piece being affixed to the wall. It is therefore to be understood that the present invention may be practiced otherwise than specifically described, without departing from the scope and spirit of the present invention. Thus, embodiments of the present invention should be considered in all respects as illustrative and not restrictive.

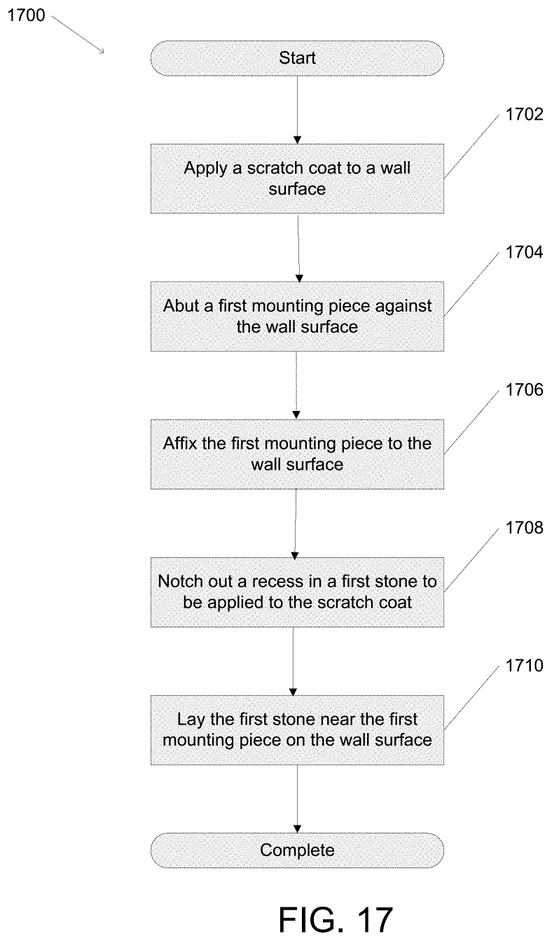

A method of embedding the mounting assembly in a rock wall is described below in accordance with embodiments of the present disclosure. The mounting assembly may be embedded in a rock wall to allow decorative items to be easily hung from the wall surface. A process for installing and using a mounting assembly including a base plate in accordance with embodiments of the present disclosure is shown in FIG. 17. The process 1700 may include applying (1702) a scratch coat to a wall surface for adhering rocks or stones to the wall surface. A first mounting piece may be abutted (1704) against the wall surface. For example, the first mounting piece may include a base portion and a protruding portion. The protruding portion may have a distal end including a pair of apertures located opposite of each other, as described above. In some embodiments, the first mounting piece may be located near a stud or between studs. In some embodiments, the base portion of the first mounting piece may be affixed (1706) to the wall surface with at least one fastener. The fastener may be one selected from a nail, screw, or anchor screw, but this disclosure is not limited by the type of fastener used to affix the first mounting piece to the wall surface.

Stones or rocks may be applied to the scratch coat of a wall surface. In some embodiments, a first stone may be notched (1708) to create a recess configured to allow the protruding portion of the first mounting piece to extend through the first stone when the first stone is applied to the scratch coat. The first stone may be applied (1710) to the scratch coat such that the protruding portion of the first mounting piece protrudes from an outer surface of the first stone such that the pair of apertures on the distal end of the protruding portion of the first mounting piece are visible or accessible.

According to some embodiments, a second stone may be notched to accommodate the first mounting piece. In such embodiments, the second stone may be notched to create a recess configured to allow the protruding portion of the first mounting piece to protrude through the second stone when the second stone is applied to the scratch coat. The second stone may be applied to the scratch coat such that the such that the pair of apertures on the distal end of the protruding portion of the first mounting piece are accessible or visible.

While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

1. A mounting assembly comprising:
a first mounting piece having a base portion and a first protruding portion, wherein a distal end of the first protruding portion includes a pair of apertures such that a first aperture is opposite a second aperture;
an interchangeable mounting piece having a second protruding portion that includes a second pair of apertures comprising a third aperture that is opposite a fourth aperture, wherein the interchangeable mounting piece is configured to slide inside the first protruding portion of the first mounting piece such that the first pair of apertures and the second pair of apertures are aligned; and
a pin member configured to be inserted in the first pair of apertures and the second pair of apertures when the first mounting piece and the interchangeable mounting piece are in a mated position;
a second interchangeable mounting piece configured to be replaceable with the interchangeable mounting piece, the second interchangeable mounting piece including a third protruding portion that includes a third pair of apertures comprising a fifth aperture and sixth aperture, wherein the second interchangeable mounting piece is configured to slide inside the first protruding portion of the first mounting piece such that the first pair of apertures and the third pair of apertures are aligned;
wherein the base portion of the first mounting piece includes at least one base portion aperture, such that the base portion is configured to be securely attached to a wall.

2. The mounting assembly of claim 1, wherein the distal end of a post of the first mounting piece is visible when securely attached to a wall.

3. The mounting assembly of claim 1 wherein the first mounting piece is a T-shaped bracket.

4. The mounting assembly of claim 1 wherein a cross-section of the protruding portion is at least one selected from a rectangle, square, circle, and oval.

5. The mounting assembly of claim 1, wherein a shape of the interchangeable mounting piece is one selected from a hoop, a hook, a rectangular trough, a circular trough, a flat face, a swirled hook, and a decorative finial.

6. The mounting assembly of claim 1, further comprising a base plate having an aperture configured to be disposed around an outer surface of the protruding portion of the first mounting piece.

7. The mounting assembly of claim 6, wherein the first mounting piece, is in a mated position with both the interchangeable mounting piece and the base plate.

8. The mounting assembly of claim 1, further comprising a detachable mounting piece configured to engage with the interchangeable mounting piece.

9. The mounting assembly of claim 8, wherein at least one of the first mounting piece, the interchangeable mounting piece, and the second interchangeable mounting piece are made of at least one selected from steel, aluminum, titanium, and acrylonitrile butadiene Styrene (ABS).

10. The mounting assembly of claim 1, wherein at least one of the first mounting piece, the interchangeable mounting piece, and the second interchangeable mounting piece are formed by at least one selected from welding, injection molding, and 3D printing.

11. The mounting assembly of claim 1, wherein at least one of the first mounting piece, the interchangeable mounting piece, and the second interchangeable mounting piece have a finish selected from matte black, glossy black, white, chrome brushed nickel, oil rubbed bronze, copper, brass, and patina.

12. A method of attaching a mounting assembly to a pre-existing wall comprising:
abutting a first mounting piece against a wall surface such that a base portion of the first mounting piece is flush against the wall surface and a protruding portion of the first mounting piece protrudes away from the wall surface, wherein a distal end of the protruding portion includes a pair of apertures such that a first aperture is opposite a second aperture;
affixing the first mounting piece to the wall surface;
sliding a portion of a first interchangeable mounting piece into the distal end of the protruding portion of the first mounting piece such that a second pair of apertures of the first interchangeable mounting piece are aligned with the first pair of apertures on the first mounting piece;
securing the first mounting piece and the first interchangeable mounting piece together; and
replacing the first interchangeable mounting piece with a second interchangeable mounting piece.

13. The method of claim 12 wherein the replacing the first interchangeable mounting piece with the second interchangeable mounting piece comprises:
removing the first interchangeable mounting piece;
sliding a portion of the second interchangeable mounting piece into the distal end of the protruding portion of the first mounting piece; and
securing the first mounting piece and second interchangeable mounting piece together.

14. The method of claim 12 wherein the affixing the first mounting piece to the wall surface comprises using one of at least a nail, screw, or anchor screw to fasten the first mounting piece to the wall surface.

15. The method of claim 12 wherein the securing the first mounting piece and the first interchangeable mounting piece together comprises placing a pin through the first pair of apertures and the second pair of apertures.

16. The method of claim 12 further comprising disposing a base plate around an outer surface of the protruding portion of the first mounting piece prior to securing the second mounting piece.

17. The method of claim 12 further comprising hanging a detachable ornamental piece from the first and the second interchangeable mounting pieces.

18. A method of embedding a mounting assembly into a wall comprising:
applying a scratch coat to a wall surface
abutting a first mounting piece against the scratch coat on the wall surface such that a base portion of the first mounting piece is flush against the wall and a protruding portion of the first mounting piece protrudes away from the wall surface, wherein a distal end of the protruding portion includes a pair of apertures such that a first aperture is opposite a second aperture;
affixing the first mounting piece to the wall surface;
notching out a recess in a first stone to be applied to the scratch coat on the wall surface such that the recess will allow the first post of the first mounting piece to protrude through the first stone;
laying the first stone proximate the first mounting piece such that at least the distal end of the post protrudes from an outer surface of the first stone and the pair of apertures are visible.

19. The method of claim 18 further comprising notching at least a second recess in a second stone to be applied to the scratch coat on the wall surface such that the recess will allow the first post of the first mounting piece to protrude through the second stone.

20. The method of claim 18 further comprising:
sliding a portion of a first interchangeable mounting piece into the distal end of the protruding portion of the first mounting piece such that a second pair of apertures of second mounting piece are aligned with the first pair of apertures;
securing the first and second mounting pieces together; and
replacing the first interchangeable mounting piece with a second interchangeable mounting piece.
